(19) United States
(12) Patent Application Publication
(10) Pub. No.: US 2026/0142913 A1
(43) Pub. Date: May 21, 2026

(54) Methods and Systems for Compact Core System Management Based on Routing Policies

(71) Applicant: T-Mobile Innovations LLC, Overland Park, KS (US)

(72) Inventor: Lyle PACZKOWSKI, Mission Hills, KS (US)

(21) Appl. No.: 18/951,444

(22) Filed: Nov. 18, 2024

(51) Int. Cl. H04L 45/302; H04L 65/1069

(52) U.S. Cl. CPC H04L 45/302; H04W 76/10; H04W 88/14

(57) ABSTRACT

A method comprises obtaining, by the central AMF, a routing policy associated with a plurality of different devices that are registered with the compact core system, wherein the routing policy indicates whether data from a first device is permitted to be transmitted to the central core network system, wherein when the data from the first device is permitted to be transmitted to the central core network system, the routing policy comprises one or more rules for transmitting the data between the first device and the central core network system, transmitting, by the central AMF, the routing policy to the compact AMF over the network slice using the UPF, and storing, by the compact AMF, the routing policy in a data store of the compact core system to configure the compact core system according to the routing policy.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A core network (sometimes referred to herein as the “core network system,” owned and operated by a telecommunications service provider (TSP)), is the central part of a telecommunications network that provides various services to users, such as voice, data, and messaging. The core network includes various components and functions for managing and routing calls, data sessions, and internet connectivity, and the core network ensures efficient and reliable communication across the network. In this way, the core network provides centralized management, scalability, high performance, and seamless user experiences across different access networks and services.

### SUMMARY

In an embodiment, a method implemented in a communication network by a compact core system for managing communications between the compact core system and an external system is disclosed. The method comprises receiving, by a compact access and mobility management function (AMF) at the compact core system, a session establishment request from a device to initiate a data session with an external system, authenticating, by the compact AMF, the device using a local unified data management (UDM) at the compact core system, and forwarding, by the compact AMF, the session establishment request to a compact session management function (SMF) at the compact core system. The method further comprises evaluating, by the compact SMF, one or more routing policies associated with the device and provisioned at the compact core system to determine whether the data session is permitted, and to determine parameters for the data session when the data session is permitted, wherein the one or more routing policies indicate whether the data session with the external system is permitted, and obtaining, by the compact SMF, one or more policy rules associated with the device and provisioned at the compact core system, in which the one or more policy rules define at least one of an allocation or management of network resources for forwarding data packets for the data session. The method further comprises configuring, by the compact SMF, a user plane function (UPF) at the compact core system to establish the data session based on the one or more routing policies and one or more policy rules, establishing, by the compact SMF using a network slice selection function (NSSF) at the compact core system, a network slice for forwarding the data packets associated with the data session, and forwarding, by the UPF over the network slice, the data packets associated with the data session between the device and the external system.

In another embodiment, a method implemented in a communication network between a compact core system and a central core network system for configuring and updating the compact core system is disclosed. The method comprises establishing, using a user plane function (UPF) at the compact core system, a connection between a compact access and mobility management function (AMF) at the compact core system and a central AMF at the central core network system over a network slice, and obtaining, by the central AMF, a routing policy associated with a plurality of different devices that are registered with the compact core system, in which the routing policy indicates whether data from a first device is permitted to be transmitted to the central core network system, and when the data from the first device is permitted to be transmitted to the central core network system, the routing policy comprises one or more rules for transmitting the data between the first device and the central core network system. The method further comprises transmitting, by the central AMF, the routing policy to the compact AMF over the network slice using the UPF, storing, by the compact AMF, the routing policy in a data store of the compact core system to configure the compact core system according to the routing policy, obtaining, by the central AMF, an update to the routing policy based on at least one of a request from an owner of the compact core system, a current network condition, or an update to a policy rule associated with the routing policy, transmitting, by the central AMF, the update to the routing policy to the compact AMF over the network slice using the UPF, and updating, by the compact AMF, the routing policy by re-configuring the compact core system according to the update to the routing policy.

In yet another embodiment, a compact core system is disclosed. The compact core system comprises one or more memories, one or more processors, a compact access and mobility management function (AMF), and a compact session management function (SMF). The one or more memories comprise a first data store configured to maintain a plurality of routing policies associated with a plurality of different devices that are registered with the compact core system, wherein each of the routing policies indicates rules for transmitting data to one or more other systems, and a second data store configured to maintain a plurality of policy rules associated with the different devices that are registered with the compact core system, wherein the policy rules are based on a subscription of the different devices and define at least one of an allocation or management of network resources for transmitting data between a first device and a central core network system. The compact AMF comprises instructions stored in the one or more memories, which when executed by the one or more processors, cause the compact AMF to be configured to establish a secure connection with a central AMF at a central core network system over a network slice using a user plane function (UPF) at the compact core system. The compact SMF comprises instructions stored in the one or more memories, which when executed by the one or more processors, cause the compact SMF to be configured to establish a data session with the first device that is registered with the compact core system. The compact AMF is further configured to obtain the data either from the first device or based on the first device, and transmit the data to the central AMF over the network slice using the UPF based on a routing policy of the routing policies indicating that the data is permitted to be transmitted and stored at the central core network system.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to various embodiments of the disclosure.

FIG. 2 is a message sequence diagram illustrating a method for configuring a customized child compact core system in the communication system of FIG. 1 according to various embodiments of the disclosure.

FIG. 3 is a is a message sequence diagram illustrating a method for sharing data between a compact core system and a central core network system 106 in the communication network of FIG. 1 according to various embodiments of the disclosure.

FIGS. 4A and 4B are message sequence diagrams illustrating a method of using routing policies to manage communications with a compact core system in the communication network of FIG. 1 according to various embodiments of the disclosure.

FIG. 5 is a flowchart of a first method for managing communications for a compact core system in the communication network of FIG. 1 according to various embodiments of the disclosure.

FIG. 6 is a flowchart of a second method for managing communications for a compact core system in the communication network of FIG. 1 according to various embodiments of the disclosure.

FIGS. 7A and 7B are block diagrams illustrating a communication system similar to the communication system of FIG. 1 according to various embodiments of the disclosure.

FIG. 8 is a block diagram of a computer system implemented within the communication system of FIG. 1 according to various embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, a central core network system is the primary controlling component of a telecommunications network, responsible for handling extensive network functions, large-scale data processing, and managing network-wide services and policies. As further described herein, the central core network system includes key functioning components, such as, for example, the Access and Mobility Management Function (AMF), Session Management Function (SMF), User Plane Functions (UPFs), Unified Data Management (UDM), Authentication Server Function (AUSF), Policy Control Function (PCF), network slice selection function (NSSF), Network Repository Function (NRF), and Network Exposure Function (NEF), each of which may ensure comprehensive network management and service delivery. The central core network system may maintain extensive databases for user authentication, authorization, and billing, and may provide high-capacity routing and data forwarding capabilities. The central core network system interacts with external networks and services, managing large volumes of traffic and complex network operations. The key functioning components of the central core network system (e.g., the AMF, SMF, UPFs, AUSF, etc.) may be applications that execute on one or more computer systems.

In contrast, a compact core system refers to a localized implementation of a subset of the core network functions provided by the central core network system, designed to provide tailored services and efficient resource management within a specific, limited area. For example, a compact core system may be designed for small to medium-sized operators, private networks, and specialized use cases such as Internet of Things deployments. The compact core system may be a standalone device or computer system that is relatively lightweight and has a small footprint, and/or the compact core system may be provisioned or installed at an existing device (e.g., modem, router, server in a data center, UE, reader device, personal computer, etc.). Compact core systems may be deployed in a variety of different environments, such as within enterprise campuses, manufacturing facilities, rural or remote areas, private networks, or implemented as a part of different types of devices (e.g., UEs, reader devices, IoT devices, smart devices, etc.).

The compact core system includes hardware components, such as servers and switches, and various software modules for the essential core network functions. When the compact core system enables a Fifth Generation (5G) wireless network, the software modules may include, for example, an AMF (sometimes referred to herein as a “compact AMF”), an SMF (sometimes referred to herein as a “compact SMF”), one or more UPFs, and a UDM.

The compact core system may be used to manage device registration, authentication, session management, data routing, security and policy enforcement, etc. The use of the compact core system for the core network functions (instead of the large-scaled centralized core network system) provides several technical benefits, such as, for example, reduced deployment costs, ease of management, and the ability to quickly scale network capacity. Moreover, positioning the compact core system within a private network or location reduces latency and improves overall data processing speeds for users.

However, compact core systems may be a pre-integrated, off-the-shelf device, which may be purchased by a customer. For example, telecommunications equipment vendors and/or TSPs may offer compact core systems as devices for purchase, in which the compact core systems are pre-loaded software and hardware components (specialized network components, software components, etc.), and the hardware may be optimized to run core network functions efficiently within the specified capacity limits. Alternatively, the software modules of a compact core system may be purchased and installed into another device or server capable of executing the software modules. Regardless of whether the compact core system is embodied as a standalone device or implemented as a software solution that may be provisioned at a customer's existing device, the compact core system may include essential core network components, such as, for example the compact AMF, the compact SMF, and one or more UPFs, and various standard databases (e.g., routing tables/forwarding tables/translation tables). The essential core network components in the compact core system may provide the necessary functionalities for handling registration, authentication, session management, and data forwarding for devices registered with the compact core system.

Compact core systems may be pre-configured to be associated with a particular TSP, and thereby only connect to central core network systems of the TSP, or the compact core systems may be pre-configured to be TSP agnostic, and may connect to the central core network systems of different TSPs with the appropriate credentials. Regardless of the TSP, the pre-integrated compact core systems may each include pre-loaded versions of the essential core network functions and databases, such that each of the functions work seamlessly together, thereby reducing the need for configuration during deployment. In this way, the owner of the pre-integrated compact core systems may easily adjust the basic configuration settings of the compact core system to fit the specific network environment in which the system is to be deployed. The pre-integration of the compact core system may only allow for minor adjustments to the core functions/storage of the system (e.g., adjusting capacity, upgrading licenses, etc.). Therefore, compact core systems may be programed and structured rigidly, with little to no room for flexibility and scalability for the customer/owner of the system, much less for a specific use case of the system. However, in some cases, compact core systems may only be used by a customer for a specific purpose or set of tasks, and therefore, the pre-loaded nature of compact core systems may be largely wasteful from a hardware and software resource perspective (i.e., various pre-loaded databases and network functions may not be used by the compact core system).

The present disclosure addresses the foregoing technical problems by providing a technical solution in the technical field of core networking, and particularly, one involving both a central core network system and one or more compact core systems. The embodiments disclosed herein are directed to a custom compact core system, which only includes the necessary software network functions and databases for a predefined purpose or use case defined by an owner of the custom compact core system. The custom compact core system may also be in a parent-child relationship with the central core network system, in which the central core network system acts as the parent and the compact core system acts as the child. The child compact core system may be programmatically controlled by the parent central core network system according to various parameters, as further described. Since the compact core systems described herein only include databases/data specific to the owner-defined use case, and only perform functions/tasks relevant and permitted by the owner-defined use case, the embodiments disclosed herein enable a more resource effective and lightweight compact core system.

The embodiments disclosed herein may be performed after the compact core system has registered with at least one central core network system and after a connection between a compact AMF at the compact core system and an AMF at the central core network system (sometimes referred to herein as the “central AMF”) has established a connection over a secure network slice. The authentication and registration of a compact core system with a central core network system is further described in U.S. patent application Ser. No. 18/791,002, entitled, “Methods and Systems for Compact Core Registration and Session Management with a Secure Connection to a Central Core Network System,” by Lyle Paczkowski (“hereinafter referred to as the “'002 Application”), which is hereby incorporated by reference in its entirety.

After registration of the compact core system is complete and the secure connection between the compact core system and the central core network system is established, an operator of the compact core system may obtain and transmit a system context of the compact core system to the central core network system (e.g., the operator may enter the context via a user interface of the compact core system). For example, the system context of the compact core system may indicate at least one of an identification of compact core system, an identification of the operator/owner of the compact core system, a location of the compact core system, a use case for the compact core system, and/or other parameters for using the compact core system for the use case/set of tasks. The use case of the compact core system may indicate, for example, that predefined types of data are being used for a business enterprise and thus may be transported to various destinations based on the parameters indicated in the context. The parameters may include permissions, prohibitions, and rules related to the services and use of the compact core system. For example, the parameters may include a list of devices permitted to connect to and use (or prohibited from connecting to or using) the compact core system, permitted source addresses and/or destination addresses for different types of data, permitted or prohibited types of data that may be transported using the compact core system, etc. The rules in the parameters may indicate, for example, whether data is to be encrypted, encoded, or processed prior to routing, whether the routing is subject to Quality of Service (QoS) or other network parameters, and/or whether the data is to be routed over a predefined network slice. While the rules in the parameters may be received in the system context in plain text form, the central AMF or an application at the central core network system may convert the rules into instructions that may be used to govern how the compact core system performs data routing with registered devices.

The central core network system may generate routing policies for the compact core system based on the system context of the compact core system, and send the routing policies to the compact AMF at the compact core system over the secure network slice. The routing policies may be encoded as predefined instructions (e.g., in the form of logic or code) that may be used to govern the routing of data by the compact core system. The routing policies may be based on at least one of an owner of the compact core system, the parameters (e.g., permissions, prohibitions, rules, etc.) received in the system context, network conditions, a location of the compact core system, etc. For example, the routing policies may indicate whether data from one or more devices are permitted to be transmitted to the central core network system, the types of data that are permitted to be transmitted to the central core network system, the devices that are permitted to transmit/receive data to and from the central core network system, etc. The routing policies may also indicate, for example, that certain devices are only permitted to transmit (or be prohibited from transmitting) data to predefined addresses associated with particular systems or data stores. The routing policies may indicate that, for example, certain devices are only permitted to receive (or be prohibited from receiving) data from predefined addresses associated with particular systems or data stores. The routing policies may also indicate, for example, that certain types of raw data are not permitted to be transmitted, but may only be transmitted after encoding (e.g., encryption, converting, processing, etc.) has been performed on the raw data. The routing policies may also indicate, for example, that data from particular devices may be entitled to different QoS parameters, or the communications with particular devices may have to be sent over a network slice with predefined parameters, etc.

In some cases, the routing policies may also include relevant portions of various databases used to perform routing according to the rules indicated in the routing policies. The databases may include, for example, a UDM with subscriber information of the devices permitted to use the compact core system, a forwarding table, policy rules applicable for the devices, etc. The forwarding table may include entries mapping the permitted destination addresses or prefixes to specific next-hop interfaces or network paths. The policy rules may include subscription-based QoS parameters, traffic prioritization rules, and access control policies tailored for the specific environment within which the compact core system is located and specific to the devices permitted to connect to the compact core system. For example, the PCF of the central core network system may obtain (e.g., determine) policy rules for the different devices connected to the compact core system.

The central AMF at the central core network system may transmit the routing policies (determined based on the system context), policy rules (determined by the PCF), and all relevant databases/data to the compact AMF at the compact core system over the network slice. The compact AMF may programmatically configure the routing policies, policy rules, and databases at the compact core system. For example, the compact AMF may store the routing policies and policy rules in a data store at the compact core system (e.g., in the form of logic and/or code), such that the routing policies and policy rules may be used to implement routing rules and additional routing-related functions during data sessions. The compact AMF may also store each of the received databases in one or more data stores at the compact core system.

In an embodiment, the central AMF may obtain an update to a routing policy for the compact core system based on various factors (e.g., a request from the owner, network conditions/outages, an update to a policy rule for a device based on current network condition, etc.). The central AMF may transmit the update to the routing policy to the compact AMF via the network slice, and the compact AMF may update the routing policy stored at the compact core system.

In an embodiment, the compact AMF may use the routing policies to determine whether data from a connected device may be communicated with another system, device, or data store. In some cases, one or more devices that are authenticated and registered with the compact core system may establish a data session (e.g., intranet file access, streaming media, Internet browsing, etc.) with another system, device, or data store via the compact core system. The compact AMF may obtain data from the device (or associated with the device) during the data session. The obtained data may include payload data captured from the data session (e.g., file access requests, data packets with webpage content/images/scripts, audio data packets, data packets containing accessed files, etc.). The obtained data may also include other types of data, such as, control data used by the devices and/or compact core system for setup and management of the data session, usage data describing an amount of data used by the devices during the session, etc.

The compact AMF may determine whether the obtained data may be shared with the central core network system based on a routing policy, which may, for example, indicate whether data from the device and/or the particular type of data is permitted to be transmitted to (and stored at) the central core network system. When permitted, the compact AMF may transmit the data to the central AMF over the network slice. In some cases, the routing policy may indicate that the data is to be processed/converted/encrypted prior to being transmitted to the central AMF. In this case, the compact AMF may convert the data based on the logic indicated in the routing policy, and then transmit the data to the central AMF.

Similarly, the compact AMF may determine whether the obtained data may be shared with an external system or data store in a data session between the device and the external system or data store based on a routing policy. For example, the routing policy may indicate whether data from the device and/or the particular type of data is permitted to be transmitted to (and stored at) the external system or data store. The routing policy may also indicate whether data packets for the data session between the device and the external system or data store are to be transmitted over a network slice that meets predefined QoS parameters. When the data session is permitted, the compact SMF at the compact core system may obtain one or more policy rules associated with the device, in which the policy rules may indicate the allocation or management of network resources for forwarding data packets to the external system or data store during the data session based on subscription data associated with the device.

The compact SMF may configure a UPF at the compact core system to establish a data session based on the routing policies and policy rules. The compact SMF and the NSSF at the compact core system establish new network slice or identify a predefined network slice that meets the QoS parameters indicated in the routing policy, and then configure the UPF to forward data packets for the data session over the network slice. The UPF may use the forwarding table and the policy rules to forward data packets according to the routing polices.

In this way, the embodiments disclosed herein enable a custom compact core system that includes only the necessary network functions and databases for a prescribed purpose or use case defined by the operator of the compact core system. Therefore, the compact core systems defined herein are far more lightweight and efficient from a processing perspective. The compact core system may work with the central core network system, in a parent-child relationship, to offload permitted types of data and tasks to the central core network system on an as needed basis. Therefore, the embodiments disclosed herein enable a more customized, lightweight compact core device while minimizing network communications, thereby decreasing network congestion and increasing network capacity.

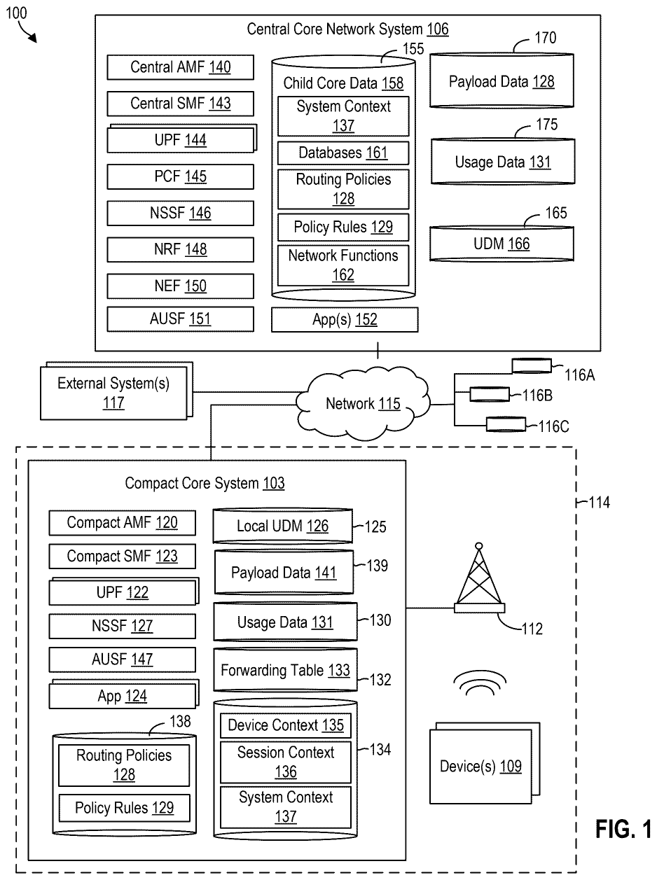

Turning now to FIG. 1, a communication network 100 is described. The communication network 100 includes a compact core system 103, a central core network system 106, device(s) 109, a cell site 112, private network 114, a network 115, external data stores 116A-C, and external system(s) 117. The private network 114 may include the compact core system 103, the device(s) 109, and the cell site 112 (although in some cases, it should be appreciated that the cell site 112 may be located outside the private network 114). The communication network 100 shown in FIG. 1 may include a single compact core system 103, a single central core network system 106, and a single cell site 112 for illustrative purposes only. However, it should be appreciated that the communication network 100 may include any number of compact core systems 103, central core network systems 106, and cell sites 112.

The device 109 may be a user equipment (UE), server, computer system, or other type of device used by an end-user or enterprise to communicate with a network 115, compact core system 103, and/or the central core network system 106, encompassing all hardware and software needed for connectivity. Examples of devices 109 embodied as a UE may include, for example, cellular phones, smartphones, tablets, laptops, headset computers, wearable computers, Internet of Things (IoT) devices, and connected cars. The cell site 112 may provide a wireless communication link to the devices 109 according to a 5G, a long term evolution (LTE), a code division multiple access (CDMA), or a global system for mobile communications (GSM) wireless telecommunication protocol. The network 115 may be one or more private networks, one or more public networks, or a combination thereof. As should be appreciated, though the network 115 is shown as being separate from the central core network system 106, in some embodiments, the network 115 may include the central core network system 106.

As mentioned above, a compact core system 103 refers to a compact and scalable mobile core network solution designed for small to medium-sized operators, private networks, and specialized use cases such as Internet of Things deployments. The compact core system 103 may be a specialized, standalone computer system with a small footprint (e.g., a lightweight device positioned in a data center, university campus, business enterprise campus, etc.). Alternatively, the compact core system 103 may be embodied programmatically into other types of devices (e.g., UEs, IoT devices, reader devices, smart devices, modems, routers, etc.).

The compact core system 103 may include various hardware and software components that may be used to manage registration of devices 109, authentication, session management, data routing, security and policy enforcement, etc. In an embodiment, the compact core system 103 may include a subset of the hardware and/or software resources in the central core network system 106. In an embodiment, the compact core system 103 may be tailored to include only the resources associated with a use case or purpose as prescribed in a context received from an owner of the compact core system 103, as further described herein.

For example, the compact core system 103 may include a compact AMF 120, a compact SMF 123, one or more UPFs 122, one or more applications 124, an NSSF 127, an AUSF 147, and other software modules also included in the central core network system 106 (as should be appreciated). The compact AMF 120 may manage registration, connection, and policy routing for connected devices 109 (e.g., devices 109 authenticated, registered, and connected with the compact core system 103), while the compact SMF 123 may handle session management, address allocation, and policy enforcement for the connected devices 109.

The one or more UPFs 122 may route and forward user data packets between the devices 109 and other systems/devices in the communication network 110. The NSSF 127 may be responsible for selecting the appropriate network slice for the compact core system 103 based on specific criteria (e.g., routing policies 128, policy rules 129) and network policies, to ensure optimal resource allocation and performance. The AUSF 147 may be responsible for authenticating devices 109 using the local UDM 126 and the compact AMF 120 to verify the identity of subscribers using various authentication methods. The AUSF 147 may use local authentication functions to verify the identity and credentials of devices 109 connecting to the compact core system 103, using locally stored or cached data at the local UDM 126. This allows the compact core system 103 to independently authenticate devices 109 without relying on the central core network system 106, enhancing responsiveness and reliability, especially in scenarios with limited connectivity to the central core network system 106. The one or more applications 124 may include instructions stored at one or more memories at the compact core system 103, which may be executable by one or more processors at the compact core system 103. The application(s) 124 may execute one or more of the functions of the compact AMF 120, compact SMF 123, UPFs 122, NSSF 127, AUSF 147 or other software modules in the compact core system 103. While the embodiment of the compact core system 103 shown in FIG. 1 only shows the compact core system 103 as including the compact AMF 120, compact SMF 123, and the UPFs 122, it should be appreciated that different variations of the compact core system 103 may include one or more additional software modules from the central core network system 106 (e.g., the PCF, NRF, NEF, etc.).

The compact core system 103 may also include different data stores (e.g., one or more memories, distributed and/or co-located) used to collect and store various types of data. In an embodiment, the compact core system 103 includes a local UDM data store 125, a policy data store 138, a content data store 139, a usage data store 130, a routing data store 132, and a context data store 134. While not shown in FIG. 1, it should be appreciated that the compact core system 103 may include various other network functions and data stores for storing different types of data (e.g., the registration data store and system data store described in the '002 Patent).

The local UDM data store 125 may be a data repository storing the local UDM 126. The local UDM 126 includes subscriber data, such as user profiles, authentication credentials, and subscription information. The local UDM 126 may facilitate user authentication, authorization, and mobility management by interacting with other core network functions, such as the compact AMF 120 and the AUSF 147 at the compact core system 103 (or the AUSF 151 and UDM 166 at the central core network system 106). The local UDM 126 may contain the subscriber data of substantially fewer users than the macro-scale UDM 166 at the central core network system 106.

For example, the system context 137 (provided by the owner of the compact core system) may include an identifier of the devices 109 and/or users that are permitted to use the services provided by the compact core system 103. The central core network system 106 may obtain the subscriber data associated with only the devices 109 and/or users indicated as permitted in the system context 137, and send the subscriber data downstream to the compact AMF 120 at the compact core system 103. The compact core system 103 may provision the received subscriber data into the local UDM 126. In another example, the local UDM 126 may be loaded with subscriber data of users residing within a predefined geographic range from the location of the compact core system 103. For example, the central AMF 140 may obtain and transmit the local subscriber data of users residing within a predefined geographic range from the location of the compact core system 103 to the compact AMF 120 after registration. The compact AMF 120 may store the subscriber data in the local UDM 126. The devices 109 indicated by the local subscriber data may be the devices 109 that are permitted to use the services provided by the compact core system 103.

The policy data store 138 may store routing policies 128 and policy rules 129. The routing policies 128 may comprise permissions, prohibitions, rules, and/or conditions (e.g., in the form of logic or code) defining a routing scheme for data packets to be transmitted during a data session for a device 109 (that is registered with the compact core system 103). As mentioned above, the routing policies 128 may be based on at least one of an owner of the compact core system 103, the parameters (e.g., the permissions, prohibitions, rules, and/or conditions) received in the system context 137, network conditions, a location of the compact core system 103, etc. For example, the routing policies 128 may indicate the types of data that are permitted to or prohibited from being sent to another system (e.g., central core network system 106 or external system 117), the sources (e.g., devices 109) that are permitted to communicate with the other systems, the addresses of data stores permitted to store data originated at the devices 109, etc.

The policy rules 129 may refer to subscription-based rules or conditions (e.g., in the form of logic or code) defining at least one of an allocation or management of network resources that may be enforced while routing data packets during a data session with a device 109. For example, the device 109 may be associated with subscription data at the local UDM 126, and the subscription data may indicate the subscription-based rules or conditions that may govern the routing of data for the device 109. For example, the policy rules 129 may encompass QoS parameters, bandwidth allocation, service prioritization, and access restrictions. In this way, the policy rules 129 may refer to predefined guidelines that dictate how network resources are allocated, managed, and prioritized for different data sessions with a device 109. In this way, the policy rules 129 may be associated with a device 109 having an established data session using the compact core system and may be based on various factors. The policy rules 129 may ensure that sessions are handled efficiently and in accordance with a user subscription associated with the device 109 and current network conditions. The compact SMF 123 may configure one or more UPFs 122 according to the routing policies 128 and policy rules 129 to optimize network performance, maintain service quality, and adhere to regulatory requirements.

The content data store 139 may receive and store payload data 141. The payload data 141 may include user data or content from the devices 109 (and/or external data stores 116 and external systems 117) that are forwarded through the network 100 during a data session established using the compact core system 103. For example, the payload data 141 may include the actual data generated by tasks performed by the devices 109, such as, file transfers, web browsing content, and voice data during calls.

The usage data store 130 may include usage data 131, which may include usage data of the devices 109 using the compact core system 103 and system usage data of the compact core system 103 in general. The usage data of the devices 109 may include data indicating an amount or volume of data sent and received by each of the devices 109, session durations, specific services accessed by each connected device 109, etc. The system usage data may encompass overall data usage by the compact core system 103, services provided to various devices 109, durations of sessions established with various devices 109, etc.

A forwarding data store 132 may store a forwarding table 133, which may be used by the UPFs 122 for forwarding data packets during a data session based on the routing policies 128 and the policy rules 129. The forward table 133 may contain entries that map permitted destination addresses (e.g., Internet Protocol (IP) address) or prefixes (as indicated in the system context) to specific next-hop interfaces or network paths. The UPFs 122 may use the forwarding table 133 to determine how to route incoming data packets efficiently within the network 100, ensuring that data reaches the identified destination in the data packets.

The context data store 134 may store the context (e.g., data describing) the devices 109, the different data sessions, and the compact core system 103. To this end, the context data store 134 may include a device context 135 describing each device 109 registered (e.g., authenticated, completed the registration process, and connected) with the compact core system 103. For example, the device context 135 may include an identity of the device 109, an address identifying a location of the device 109, an authentication status of the device 109, various capabilities of the device 109, the types of data that the device 109 is permitted to send and receive (or prohibited from sending and receiving), the other systems/devices/servers which are permitted to communicate with the device 109 (or prohibited from communicating with the device 109), etc.

The context data store 134 may include a session context 136 describing the different data sessions established by the compact core system 103. The session context 136 may indicate the addresses of the devices 109 and external systems 117 communicating during the data session, QoS parameters for the data session, service flow descriptions for the data sessions, the routing policies 128 and/or policy rules 129 applied during the data session, etc.

The context data store 134 may also include the system context 137 describing the compact core system 103. For example, the system context 137 of the compact core system may indicate at least one of an identification of compact core system 103, an identification of the operator/owner of the compact core system 103, an address identifying a location of the compact core system 103, a use case for the compact core system 103, and/or other parameters (e.g., rules) for using the compact core system 103 to provide services to the operator/owner.

In some embodiments, the compact core system 103 may also include a display and a user interface (e.g., touchscreen or keyboard/dialer). As further described herein, the operator of the compact core system 103 may use the user interface to access an application or webpage associated with a TSP and enter at least a portion (e.g., the parameters) of the system context 137. The compact AMF 120 at the compact core system 103 may transmit the system context 137 to the central AMF 140 at central core network system 106. In another embodiment, an operator of the compact core system 103 may use another computer system to provide the system context 137 to the central core network system 106.

The central core network system 106 may be a distributed and interconnected collection of computer systems, servers, memories, processors, etc. that create a full-scale, centralized core network for handling extensive network management, control, and data processing tasks across a large geographical area, incorporating comprehensive functionalities. As shown in FIG. 1, the central core network system 106 may include a central AMF 140, a central SMF 143, one or more UPFs 144, a PCF 145, a NSSF 146, a NRF 148, a NEF 150, an AUSF 151, and one or more applications 152. The central AMF 140 may be similar to the compact AMF 120, except that the central AMF 140 manages a larger volume of devices 109 over an extensive geographical coverage area to manage high levels of signaling traffic and complex mobility scenarios. The central AMF 140 may also be fully integrated with other central core network system 106 functionalities, and thus may require substantially more computational and storage resources to manage and process data at the larger scale, to ensure robust performance and redundancy.

The central SMF 143 may operate similar to the compact SMF 123, except that the central SMF 143 may also manage session control and data paths for a larger volume of devices 109 over an extensive geographical coverage area. The central SMF 143 may also be fully integrated with other central core network system 106 functionalities, and thus may require substantially more computational and storage resources to manage and process data at the larger scale, to ensure robust performance and redundancy. The UPFs 144 may operate in the user plane to control traffic for devices 109 connected to the central core network system 106.

The PCF 145 is responsible for obtaining (e.g., determining) and managing policy rules 129 and QoS parameters in the network 100, ensuring that resources are allocated according to predefined policies and service agreements. The NSSF 146 may be responsible for selecting appropriate network slices for device 109 based on service requirements and network conditions, enabling tailored network performance and functionality. The NRF 148 manages a repository of available network functions and their capabilities, allowing other network components to discover and communicate with these functions dynamically. The NEF 150 (or another network expansion function) may provide a secure interface for external applications to interact with the central core network system 106, exposing network capabilities and services while managing security and policy compliance.

The central core network system 106 may also include different data stores (e.g., one or more memories, distributed and/or co-located) used to collect and store various types of data. The central core network system 106 may include a UDM data store 165, a child core data store 155, a child content data store 170, and a child usage data store 175. While not shown in FIG. 1, it should be appreciated that the central core network system 106 may include various other data stores for storing different types of data (e.g., the registration data store and system data store described in the '002 Patent).

The UDM data store 165 may store the UDM 166. The UDM 166 may be a large-scale data repository storing user subscription data and profiles (e.g., for devices 109 and compact core systems 103), providing essential information for authentication, authorization, and service provisioning. The UDM 166 may include subscription data for far more user accounts than the local UDM 126 in the compact core system 103. The AUSF 151 may handle the authentication processes for devices 109 and/or compact core systems 103 by verifying security credentials and ensuring secure access to the central core network system 106 using the UDM 166.

The child core data store 155 may store child core data 158 associated with each of the child compact core systems 103 operating in conjunction with the central core network system 106 (e.g., in a parent-child relationship). The child core data 158 may include the system context 137. From the system context 137 (e.g., which may be in plain text form), the application 152 may generate the logic and/or code for the routing policies 128 and policy rules 129 for each of the devices 109 that are permitted to register with the compact core system 103. The application 152 may also use the system context 137 to determine the databases 161 that are already provisioned and/or to be provisioned at the compact core system 103 (e.g., the subscriber data that is to be sent to the local UDM 126, the routing policies 128, policy rules 129, the entries in the forwarding table 133, etc.). The child core data 158 may also indicate the network functions 162 provisioned at the compact core system 103 (e.g., the compact AMF 120, the compact SMF 123, UPFs 122, NSSF 127, AUSF 147, etc.).

The child content data store 170 may store the payload data 141 that the compact core system 103 is permitted to share with the central core network system 106 for storage (e.g., for offloading, redundancy, or failover purposes.) The child usage data store 175 may store the usage data 131 that is permitted to be shared with the central core network system 106 for storage (e.g., for billing and charging purposes when the central core network system 106 is responsible for billing the users of the compact core system 103 and/or the owner of the compact core system 103).

Data stores 116A-C may refer to external data centers, data repositories, memories, etc., positioned external to the private network 114, as shown in FIG. 1. Each of the data stores 116A-C may have different addresses and corresponding locations. For example, each of the data stores 116A-C may correspond to different data centers or cloud-based environments configured with servers and memories for storing data on behalf of an enterprise customer operating the compact core system 103.

The external system 117 may be a collection of various hardware and software components that provide a service to the devices 109 over the network 115 using the services provided by the compact core system 103. The external system 117 may also be positioned external to the private network 114 (although it should be appreciated that systems 117 may also be positioned within the private network 114 as well for purposes of data communications). For example, the external system 117 may correspond to Internet services, enterprise networks, data centers, public safety networks, IoT platforms, etc.

In an embodiment, the central core network system 106 and the compact core system 103 may have access to an external system in which a predictive or machine learning model has been provisioned. The central core network system 106 and/or the compact core system 103 may feed data to the model to train the model to generate outputs with recommendations and/or suggestions based on a threshold confidence score. The generated outputs may be used to perform various tasks as disclosed herein. For example, in some cases, the system context 137 may not include at least some of the parameters used to generate the routing policies 128. Instead, the system context 137 may only include the identification of the compact core system 103, an identification of the operator, owner, and/or customer of the compact core system 103, an address identifying a location of the compact core system 103. The model may have previously been trained with historical data associated prior system contexts 137 with corresponding routing policies 128. As such, a current system context 137 may be fed into the model to output predicted routing policies 128, which may be confirmed or rejected by an operator of the compact core system 103.

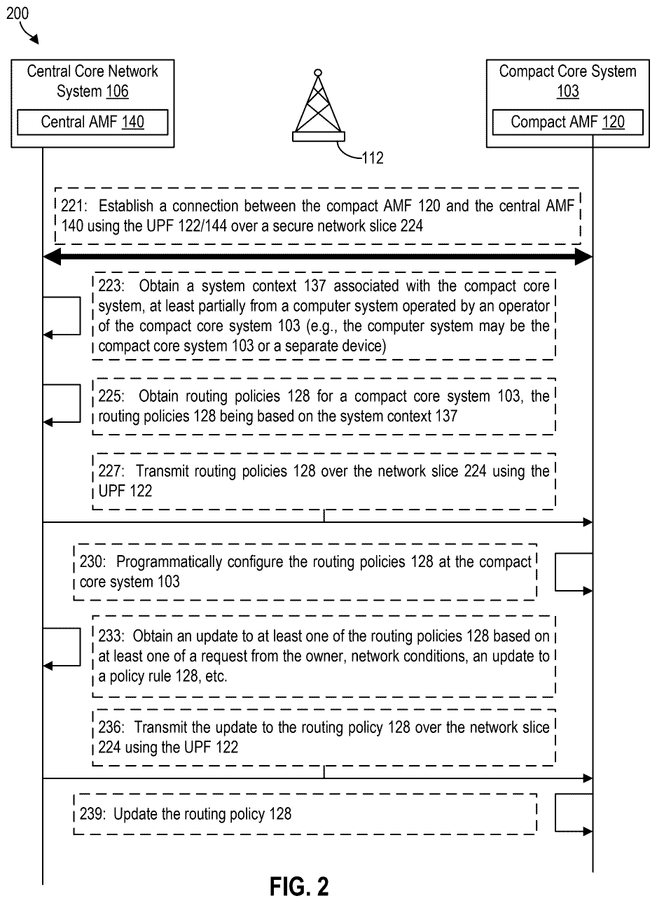

Referring now to FIG. 2, shown is a message sequence diagram illustrating a method 200 for configuring a customized child compact core system 103 using a parent central core network system 106 according to various embodiments of the disclosure. The method 200 may be performed after the compact core system 103 has completed registration with the central core network system 106 and after a connection is established between the compact AMF 120 and the central AMF 140 using the UPFs 122, 144 over a secure network slice 224 (as described in the '002 Patent). The method 200 may be performed by the central AMF 140 of the central core network system 106 and the compact AMF 120 of the compact core system 103. At operation 221, the central core network system 106 establishes a connection between the compact AMF 120 and the central AMF 140 using the UPF over a secure network slice.

At operation 223, the central AMF 140 may obtain a system context 137 at least partially from a computer system operated by an operator/user or owner of the compact core system 103. In an embodiment, the computing device may be the compact core system 103, and the compact core system 103 may include the user interface and the display through which the operator may enter one or more parameters of the system context 137. Alternatively, the computing device may be a separate device through which the user logs in to an account associated with a TSP operating the central core network system 106 and/or the compact core system 103, and then enters one or more parameters of the system context 137.

The computing device may transmit the parameters to the central AMF 140 at the central core network system 106. For example, the parameters may include a list of devices permitted to connect to and use (or prohibited from connecting to or using) the compact core system (e.g., identifications or addresses of devices), permitted source addresses and/or destination addresses for different types of data, permitted or prohibited types of data that may be transported using the compact core system, etc. For example, the parameters may include a type of encoding, processing, and/or encryption/decryption scheme that may be used on particular types of data before the data may be transmitted to the destination address, etc.

In some cases, the compact core system 103 may be programmed to automatically transmit certain attributes of the system context 137 to the central AMF 140 via the network slice 224 in response to at least one of the compact core system 103 completing registration with the central core network system 106 or the operator sending the parameters of the system context 137 to the central core network system 106. The attributes of the system context 137 that the compact core system 103 automatically obtains (e.g., determines or receives from a local data store) and transmits to the central core network system 106 (e.g., without operator intervention or action) may include, for example, the identification of the compact core system 103, an identification of the operator, owner, and/or customer of the compact core system 103, an address identifying a location of the compact core system 103, etc.

At operation 225, the central AMF 140 may obtain routing policies 128 associated with the compact core system 103 based on the received system context 137. For example, the central AMF 140 or the application 152 may extract the parameters from the system context 137 and generate the routing policies 128 in the form of instructions (e.g., logic, code, rules, etc.) that may be executed to enforce the permissions, prohibitions, rules, conditions, etc., as indicated in the parameters of the system context 137. At operation 227, the central AMF 140 may transmit the routing policies 128 (e.g., in message) over the network slice 224 using the UPF 122 (e.g., in a standardized interpretable format).

At operation 230, the compact AMF 120 of the compact core system 103 may programmatically configure the routing policies 128 at the compact core system 103. The compact AMF 120 may store the routing policies 128 in a routing data store 138 at the compact core system 103. For example, the compact AMF 120 may parse a received message to extract the routing policies 128, translate the routing policies 128 into actionable configuration changes in the form of instructions (e.g., logic, code, rules, etc.), and store the routing policies 128 at the routing data store 138, such that the compact AMF 120, compact SMF 123, and/or UPFs 122 are configured to manage the routing of data packets for a data session according to the routing policies 128.

At operation 233, after the routing policies 128 have been programmed at the compact core system 103, the central AMF 140 may obtain an update of at least one of the programmed routing policies 128. The update may be based on a request from the owner, network conditions, an update to a policy rule 129 applicable to the routing policy 128, etc. For example, the update may be based on a request from the owner when the owner submits an update to one or more parameters (e.g., permissions, prohibitions, processing configurations, etc.) of the system context 137 (e.g., via a user interface of a computer system). The update may be based on network conditions when, for example, an outage is detected at a cell site 112 serving one of the devices 109 that is registered with and connected to the compact core system 103. The update may be based on a policy rule 129 applicable to the routing policy 128 when, for example, a modification of a QoS parameter subscribed for by the device has been modified.

At operation 236, the central AMF 140 may transmit the update to the routing policy 128 over the network slice 224 using the UPF 122. At operation 239, after receiving the update to the routing policy 128, the compact AMF 120 (or the application 124 at the compact core system 103) may update the routing policy 128 at the routing data store 138. For example, the instructions of the routing policy 128 may be updated to reflect the new rules, conditions, permissions, or prohibitions indicated in the update to the routing policy 128.

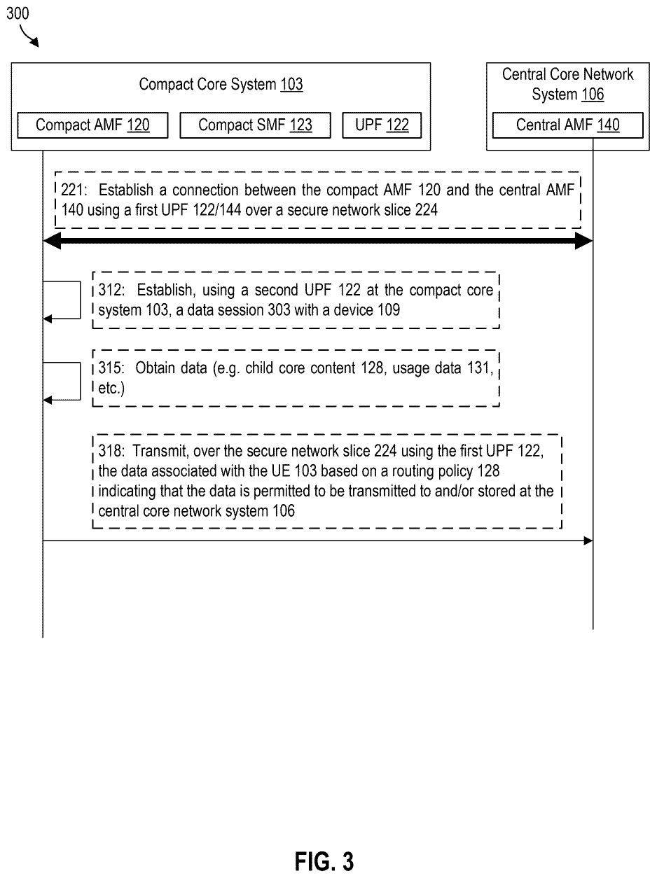

Referring now to FIG. 3, shown is a message sequence diagram illustrating a method 300 for sharing data between a compact core system 103 and the central core network system 106 according to various embodiments of the disclosure. The method 300 may be performed after the compact core system 103 has completed registration with the central core network system 106 and after a connection is established between the compact AMF 120 and the central AMF 140 using a first UPF 122 over a secure network slice 224 (as described in the '002 Patent). Method 300 may also be performed after the routing data store 138 has been established to maintain the routing policies 128 and policy rules 129 for a device 109 having an established data session using the compact core system 103. Method 300 may also be performed after the forwarding database 132 has been established to maintain the entries in the forwarding table 133 for forwarding data to and from the central core network system 106. Method 300 may be performed by the central AMF 140 of the central core network system 106 and the compact AMF 120, compact SMF 123, and one or more UPFs 122 of the compact core system 103.

At operation 312, the compact AMF 120 (and the compact SMF 123) at the compact core system 103 may establish a data session 303 with a device 109 that is authenticated with the compact core system 103 and registered with the compact core system 103. The data session 303 may be established using a second UPF 122 at the compact core system 103. The device 109 may be indicated, in the system context 137, as one that is permitted to use the services of the compact core system 103. The data session 303 may be established in response to the device 109 transmitting a session establishment request to the compact AMF 120, and the compact SMF 123 configuring session parameters using policy rules 129 associated with the device 109, the other party (e.g., destination) of the data session, current network conditions, etc. The compact SMF 123 may configure a UPF 122 to handle the actual data packet forwarding for the data session using the entries in the forwarding table 133.

At operation 315, the compact AMF 120 may obtain data either from the device 109 or based on the device 109 or data session. For example, the data may include payload data 141, which may be the actual user data obtained during the data session. The data may also include usage data 131 or other data that is related to the data session and/or device 109 and received by the compact core system 103.

In an embodiment, a routing policy 128 of the device 109 may indicate whether the data is permitted to be shared with the central core network system 106. For example, a routing policy 128 may indicate that all data from the device 109 is to be (or permitted to be) forwarded/shared with the central core network system 106 for purposes of offloading, georedundancy, failover, etc. (e.g., based on a priority of the device 109 or the data). However, a routing policy 128 may also indicate that the type of data obtained may not be shared with the central core network system 106 due to the sensitivity of the data (e.g., the data may contain personally identifiable information (PII)).

At operation 318, the compact AMF 120 may transmit the data to the central AMF 140 over the secure network slice 224 using the first UPF 122 based on a routing policy 128 indicating that the data is permitted to be transmitted to and/or stored at the central core network system 106. The central AMF 140 may receive the data and store the data in the proper data store 155, 170, or 175 based on the type of data that is received, and based on whether the routing policy 128 indicates that the data is permitted to be stored at the central core network system 106.

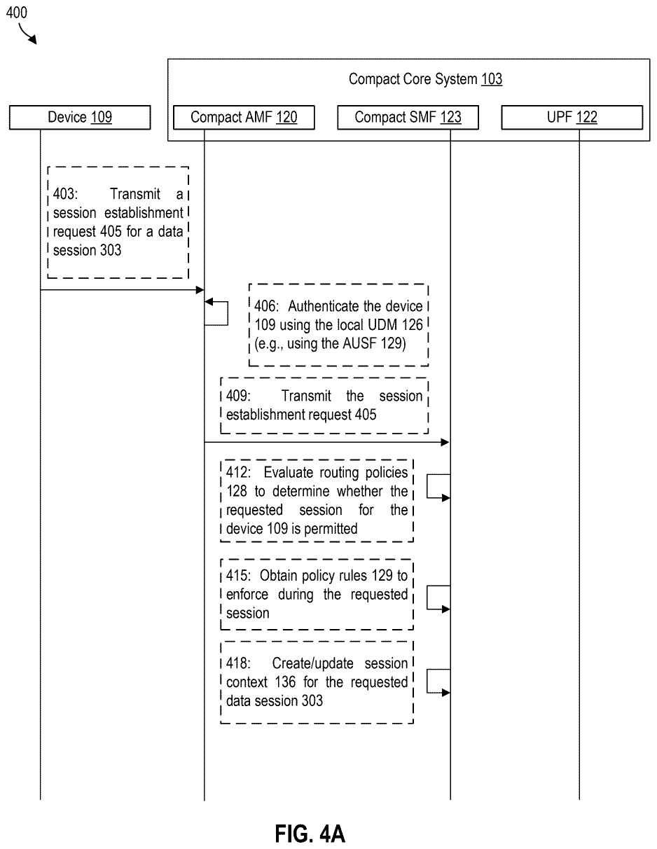

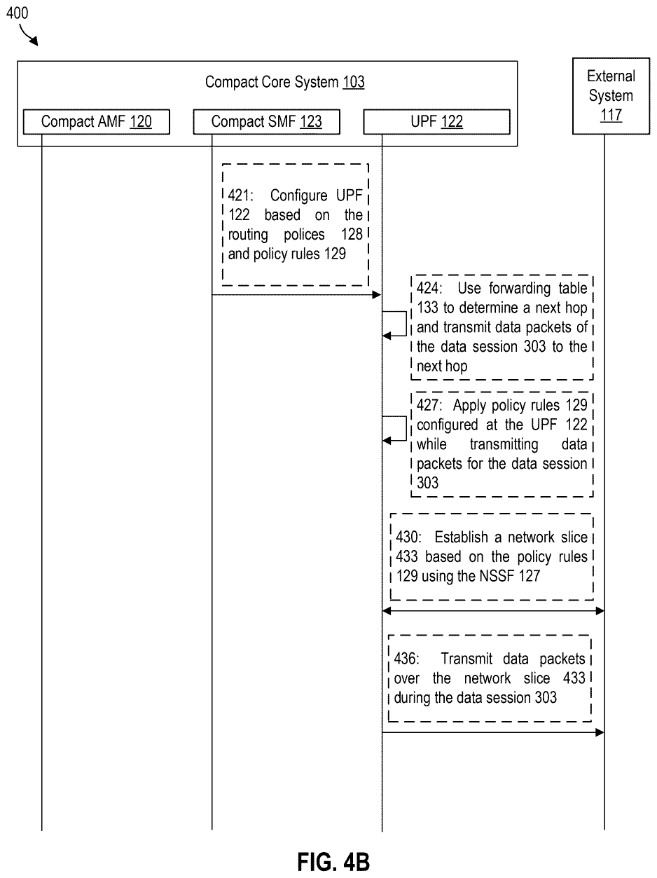

Referring now to FIGS. 4A and 4B, shown is a message sequence diagram illustrating a method 400 for using the routing policies 128 and policy rules 129 to manage communications during a data session according to various embodiments of the disclosure. Method 400 may also be performed after the routing data store 138 has been established to maintain the routing policies 128 and policy rules 129 for a device 109 having an established data session using the compact core system 103. Method 300 may also be performed after the forwarding database 132 has been established to maintain the entries in the forwarding table 133 for forwarding data to and from the central core network system 106. Method 400 may be performed by a device 109 and the compact AMF 120, compact SMF 123, and one or more UPFs 122 of the compact core system 103.

Turning now to FIG. 4A, method 400 begins with operation 403. At operation 403, the device 109 may transmit a session establishment request 405 for a data session 303 to the compact AMF 120 of the compact core system 103. The session establishment request 405 is a message sent by the device 109 to initiate a new data session 303, specifying the desired service type, QoS parameters, and other session data. To this end, the session establishment request 405 may include an identification of the device 109 (e.g., Mobile Station International Subscriber Directory Number (MSISDN)), an identification (e.g., address/IP address, Uniform Resource Locator (URL)) of the other party of the data session 303 (e.g., an external system 117 or external data store 116A-C), the desired QoS parameters requested by the device 109, requested resources, relevant policy information used to allocate resources and configure the session appropriately, etc.

At operation 406, the compact AMF 120 may authenticate the device 109 (with the AUSF 147) using the local UDM 126 (e.g., to determine whether the device 109 is authenticated and registered with the compact core system 103 and is associated with a user account in the local UDM 126). For example, the compact AMF 120 may query the local UDM 126 for the subscription data and authentication credentials associated with the requesting device 109. The AUSF 147 and/or local UDM 126 may authenticate the device 109 based on the data received in the session establishment request 405. At operation 409, the compact AMF 120 may transmit the session establishment request 405 to the compact SMF 123. The compact AMF 120 may also include relevant context information, such as a location of the device 109, an authentication status of the device 109, QoS parameters, etc., in the forwarded session establishment request 405.

At operation 412, the compact SMF 123 may evaluate routing policies 128 associated with the device 109 to determine whether the data session 303 requested by the session establishment request 405 is permitted based on, for example, a type of data session 303, the device 109, the other parties of the data session 303, a location of the device 109 and/or a location the other parties of the data session 303, etc. For example, one or more routing policies 128 for the device 109 may indicate that the requested data session 303 is not permitted for the device 109, in which case the compact AMF 120 may return a rejection of the session establishment request 405 to the device 109. As another example, one or more routing policies 128 for the device 109 may indicate that the requested data session 303 is permitted and that data (after encryption) is permitted to be transmitted to the other parties of the data session 303 for a predefined period of time.

At operation 415, the compact SMF 123 may then obtain policy rules 129 associated with the device 109 that are to be enforced during the requested data session 303. For example, the policy rules 129 may indicate that subscribed-for QoS parameters are to be applied during the data session 303 for the device 109, traffic routing rules, and/or forwarding paths for routing data packets during the data session. The policy rules 129 may indicate that the communications for the data session 303 may have to be sent over a network slice (e.g., either a preexisting network slice or a newly established network slice) that meets the QoS parameters and other security enhancements. At operation 418, the compact SMF 123 may create/update a session context 136 (e.g., stored at the context data store 134) for the requested data session 303 based on the evaluated routing policies 128 and the obtained policy rules 129.

Turning now to FIG. 4B, method 400 continues with operation 421. At operation 421, the compact SMF 123 may configure one or more UPFs 122 based on the routing policies 128 and/or the policy rules 129. For example, the compact SMF 123 may configure the UPFs 122 by sending the UPFs 122 instructions that may include the QoS parameters, the identification of the network slice, the forwarding paths, the traffic steering rules, etc., indicated in the policy rules 129.

At operation 424, the UPF 122 may use the forwarding table 133 to determine a next hop (or next hop interface) over which to transmit data packets for the data session 303. The UPF 122 may then begin transmitting data packets of the data session 303 to the determined next hop. At operation 427, the UPF 122 may apply the policy rules 129 (e.g., configured at the UPF at operation 421) while transmitting data packets for the data session 303.

When the policy rules 129 indicate that the communications for the data session 303 are to forwarded over a network slice, then at operation 430, the UPF 122 and the other parties of the data session 303 (e.g., the external system 117 shown in FIG. 4B) may establish or identify a network slice 433 using the NSSF 127 based on the policy rules 129. The SMF 123 may communicate with the NSSF 127 to determine the appropriate predefined network slice 433 or to establish a new network slice 433 based on factors such as service requirements, QoS parameters, user preferences, and current network conditions. For example, the QoS parameters may indicate a minimum and/or maximum bandwidth, latency requirements, packet loss tolerance, priority levels, etc. The network slice 433 may meet the QoS parameters and other networking attributes indicated in the policy rules 129 associated with the device 109 and the session establishment request 405. In an embodiment, establishing the network slice 433 comprises configuring, by the compact SMF 123, the UPF 122 with QoS parameters and traffic policies defined for the network slice 433. At operation 436, the UPF 122 may transmit and receive data packets between the device 109 and the external system 117 over the network slice 433 during the data session 303.

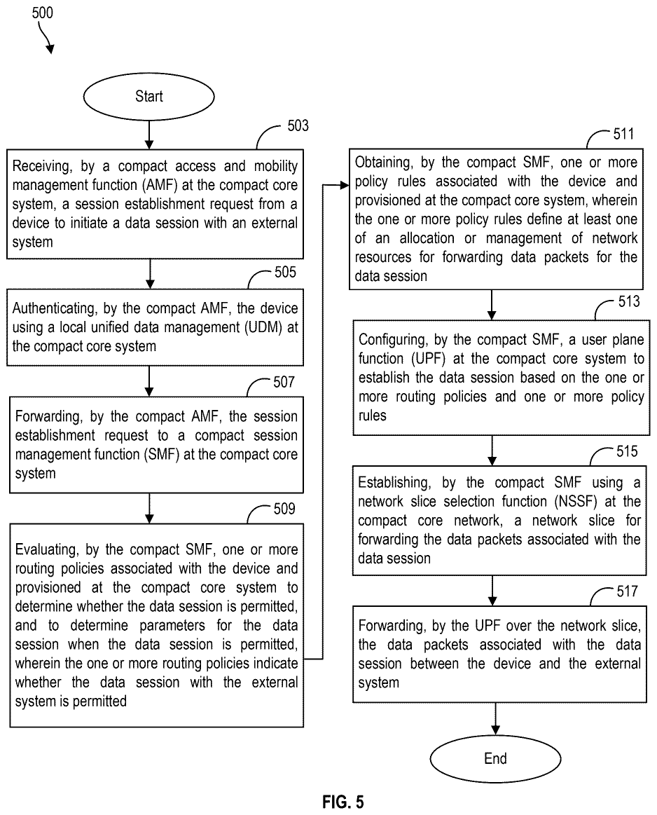

Referring now to FIG. 5, shown is a method 500 for managing communications between the compact core system 103 and an external system 117 according to various embodiments of the disclosure. Method 500 may be performed by the compact core system 103, the central core network system 106, and the device 109. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises receiving, by the compact AMF 120, a session establishment request 405 from a device 109 to initiate a data session with 303 an external system 117. At step 505, method 500 comprises authenticating, by the compact AMF 120, the device 109 using a local unified data management (UDM) 126 at the compact core system 103. At step 507, method 500 comprises forwarding, by the compact AMF 120, the session establishment request 405 to a compact SMF 123 at the compact core system 103.

At step 509, method 500 comprises evaluating, by the compact SMF 123, one or more routing policies 128 associated with the device 109 and provisioned at the compact core system 103 to determine whether the data session 303 is permitted, and to determine parameters for the data session when the data session is permitted. The one or more routing policies 128 indicate whether the data session 303 with the external system 117 is permitted.

At step 511, method 500 comprises obtaining, by the compact SMF 123, one or more policy rules 129 associated with the device 109 and provisioned at the compact core system 103. The one or more policy rules 129 define at least one of an allocation or management of network resources for forwarding data packets for the data session 303. At step 513, method 500 comprises configuring, by the compact SMF 123, a UPF 122 at the compact core system 103 to establish the data session 303 based on the one or more routing policies 128 and one or more policy rules 129. At step 515, method 500 comprises establishing, by the compact SMF 123 using the NSSF 127 at the compact core system 103, a network slice 433 for forwarding the data packets associated with the data session 303. At step 517, method 500 comprises forwarding, by the UPF 122 over the network slice 433, the data packets associated with the data session 303 between the device 109 and the external system 117.

Method 500 may include other steps and features not otherwise shown in FIG. 5. In an embodiment, a policy rule 129 of the one or more policy rules 129 indicates that the data packets associated with the data session 303 are to be forwarded over the network slice 433 that meets predefined QoS parameters. In an embodiment, after evaluating the one or more routing policies 128 and obtaining the one or more policy rules 129, method 500 may further comprise updating a session context 136 to indicate at least one of addresses of the device 109 and external system 117, QoS parameters for the data session 303, service flow descriptions for the data session, the one or more routing policies 128, or the one or more policy rules 129.

In an embodiment, configuring the UPF 122 at the compact core system 103 based on the one or more routing policies 128 and one or more policy rules 129 comprises at least one of assigning QoS parameters to the UPF 122, defining routes or next hop destinations for the data packets, or enforcing handling conditions (e.g., load balancing/traffic prioritization) based on the one or more policy rules 129. In an embodiment, establishing the network slice 433 comprises configuring, by the compact SMF 123, the UPF 122 with QoS parameters and traffic policies defined for the network slice 433.

In an embodiment, the local UDM 126 maintains only subscriber profiles associated with one or more devices 109 that are registered with the central core network system 106 and permitted to use services provided by the compact core system 103 (e.g., as indicated in the system context 137). In an embodiment, method 500 may comprise maintaining, at the compact core system 103, a forwarding table 133 that maps permitted destination addresses to a next-hop interface or destination within a local network, in which forwarding, by the UPF 122 over the network slice 433, the data packets associated with the data session 303 between the device 109 and the external system 117 comprises forwarding the data packets to the next-hop interface based on the forwarding table 133.

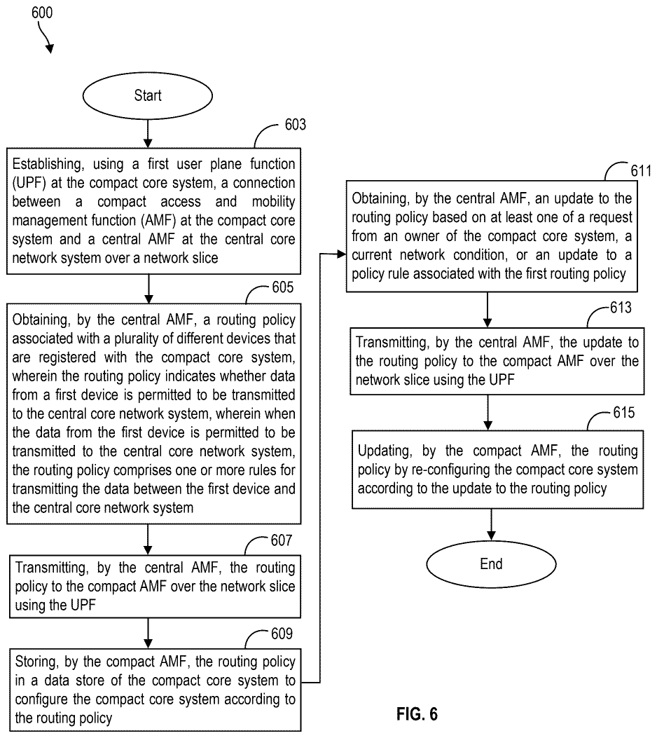

Referring now to FIG. 6, shown is a method 600 for configuring and updating the compact core system 103 according to various embodiments of the disclosure. Method 600 may be performed by the compact core system 103 and the central core network system 106. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 comprises establishing, using a UPF 122 at the compact core system 103, a connection between an AMF 120 at the compact core system 103 and a central AMF 140 at the central core network system 106 over a network slice 224. At step 605, method 600 comprises obtaining, by the central AMF 140, a routing policy 128 associated with a plurality of different devices 109 that are registered with the compact core system 103. The routing policy indicates whether data from a first device 109 is permitted to be transmitted to the central core network system 106. When the data from the first device 109 is permitted to be transmitted to the central core network system 106, the routing policy 128 comprises one or more rules for transmitting the data between the first device 109 and the central core network system 106. For example, the rules may indicate whether the data is to be encode, encrypted, or otherwise processed prior to sending to the central core network system 106. For example, the rules may indicate whether the data is to be transmitted over a network slice 433, or may otherwise be subject to other QoS parameters during transmission.

At step 607, method 600 comprises transmitting, by the central AMF 140, the routing policy 128 to the compact AMF 120 over the network slice 224 using the UPF 122. At step 609, method 600 comprises storing, by the compact AMF 120, the routing policy in a data store 138 of the compact core system 103 to configure the compact core system 103 according to the routing policy 128.

At step 611, method 600 comprises obtaining, by the central AMF 140, an update to the routing policy 128 based on at least one of a request from an owner of the compact core system 103, a current network condition, or an update to a policy rule 129 associated with the routing policy 128. The policy rule 129 may be rules obtained (e.g., generated or determined) based on subscription data associated with the devices 109 and current network conditions. At step 613, method 600 comprises transmitting, by the central AMF 140, the update to the routing policy 128 to the compact AMF 120 over the network slice 224 using the UPF 122. At step 615, method 600 comprises updating, by the compact AMF 120, the routing policy 128 by re-configuring the compact core system 103 according to the update to the routing policy 128.

Method 600 may include other steps and/or features that are not otherwise shown in FIG. 6. In an embodiment, the routing policy 128 indicates that data of a first type that is received from a first device 109 registered with the compact core system 103 is to be transmitted to the central core network system 106 over a first predefined network slice 433 having a first set of QoS parameters. In an embodiment, the update to the routing policy 128 indicates a second predefined network slice 433 with a second set of QoS parameters, and updating the routing policy 128 comprises storing an updated routing policy 128 in the data store 138. The updated first routing policy 128 indicates that the data of the first type that is received from the first device 109 is to be transmitted to the central core network system 106 over the second network slice 433.

In an embodiment, the routing policy 128 indicates that data received from a first device 109 registered with the compact core system 103 is to be encrypted according to a first encryption algorithm using a predefined encryption key prior to transmission. In an embodiment, the update to the routing policy 128 indicates that the data received from the first device 109 is to be encrypted according to a second encryption algorithm using a second predefined encryption key prior to transmission, and updating the routing policy 128 comprises storing an updated first routing policy 128 in the data store 138. The updated first routing policy 128 indicates that the data received from the first device 109 is to be encrypted according to a second encryption algorithm using a second predefined encryption key prior to transmission.

In an embodiment, the routing policy 128 indicates that raw data received from devices 109 registered with the compact core system 103 is prohibited from being forwarded to an external system 117. In this embodiment, an encrypted version of the raw data is permitted to be forwarded to the external system.

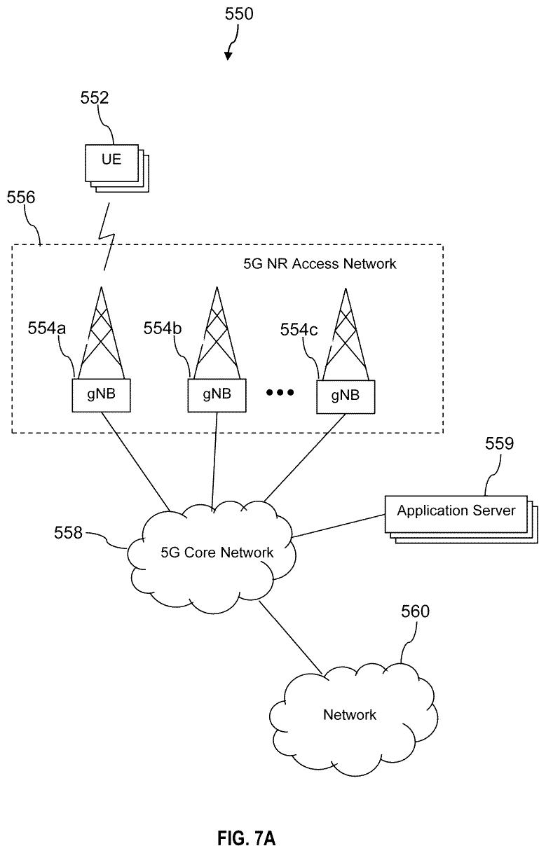

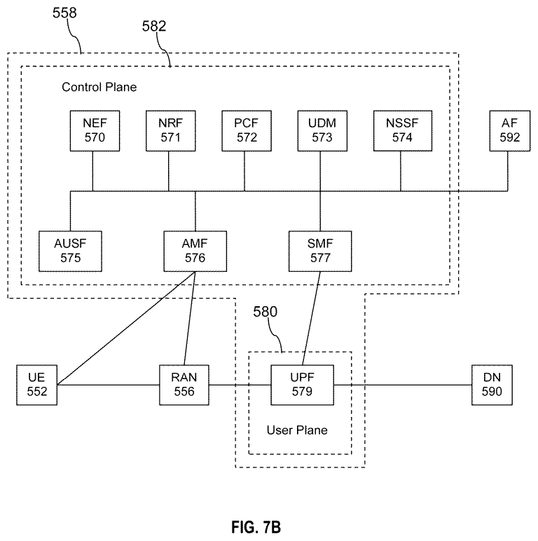

Turning now to FIG. 7A, an exemplary communication system 550 is described. In an embodiment, the communication system 550 may be implemented in the network 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices (whether or not user operated), or devices such as device 109 can operate. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, the core network 558 described in FIGS. 5A-B may be similar to the central core network system 106 (e.g., the larger-scaled core network) and in some cases, similar to the central core network system 106 (e.g., may include similar network functions, but on a smaller scale).

In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 7B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

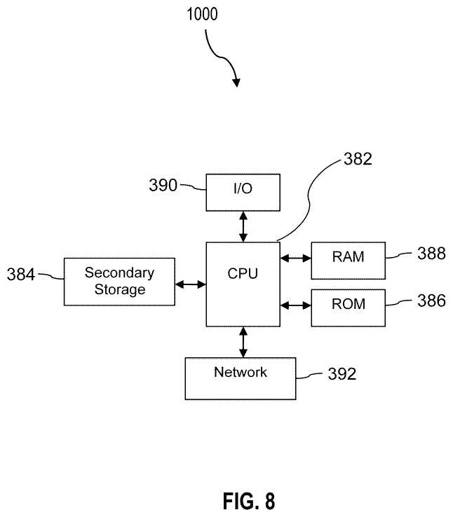

FIG. 8 illustrates a computer system 1000 suitable for implementing one or more embodiments disclosed herein. In an embodiment, the devices 109 and/or the compact core system 103 may each be implemented as the computer system 1000. The computer system 1000 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 1000, at least one of the CPU 382, the RAM 388, and the ROM 386 are changed, transforming the computer system 1000 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1000 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 1000 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1000 to provide the functionality of a number of servers that is not directly bound to the number of computers in the computer system 1000. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1000, at least portions of the contents of the computer program product to the secondary storage 384, to the ROM 386, to the RAM 388, and/or to other non-volatile memory and volatile memory of the computer system 1000. The processor 382 may process the executable instructions and/or data structures in part by directly accessing the computer program product, for example by reading from a CD-ROM disk inserted into a disk drive peripheral of the computer system 1000. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 1000.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 1000 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network by a compact core system for managing communications between the compact core system and an external system, wherein the method comprises:
receiving, by a compact access and mobility management function (AMF) at the compact core system, a session establishment request from a device to initiate a data session with an external system;
authenticating, by the compact AMF, the device using a local unified data management (UDM) at the compact core system;
forwarding, by the compact AMF, the session establishment request to a compact session management function (SMF) at the compact core system;
evaluating, by the compact SMF, one or more routing policies associated with the device and provisioned at the compact core system to determine whether the data session is permitted, and to determine parameters for the data session when the data session is permitted, wherein the one or more routing policies indicate whether the data session with the external system is permitted;
obtaining, by the compact SMF, one or more policy rules associated with the device and provisioned at the compact core system, wherein the one or more policy rules define at least one of an allocation or management of network resources for forwarding data packets for the data session;
configuring, by the compact SMF, a user plane function (UPF) at the compact core system to establish the data session based on the one or more routing policies and one or more policy rules;
establishing, by the compact SMF using a network slice selection function (NSSF) at the compact core system, a network slice for forwarding the data packets associated with the data session; and
forwarding, by the UPF over the network slice, the data packets associated with the data session between the device and the external system.

2. The method of claim 1, wherein a policy rule of the one or more policy rules indicates that the data packets associated with the data session are to be forwarded over the network slice that meets predefined quality of service (QoS) parameters.

3. The method of claim 1, wherein after evaluating the one or more routing policies and obtaining the one or more policy rules, the method further comprises updating a session context to indicate at least one of addresses of the device and external system, quality of service (QoS) parameters for the data session, service flow descriptions for the data session, the one or more routing policies, or the one or more policy rules.

4. The method of claim 1, wherein configuring the UPF at the compact core system based on the one or more routing policies and one or more policy rules comprises at least one of assigning quality of service (QoS) parameters to the UPF, defining routes or next hop destinations for the data packets, or enforcing handling conditions based on the one or more policy rules.

5. The method of claim 1, wherein establishing the network slice comprises configuring, by the compact SMF, the UPF with quality of service (QoS) parameters and traffic policies defined for the network slice.

6. The method of claim 1, wherein the local UDM maintains only subscriber profiles associated with one or more devices that are registered with a central core network system and permitted to use services provided by the compact core system.

7. The method of claim 1, further comprising maintaining, at the compact core system, a forwarding table that maps permitted destination addresses to a next-hop interface or destination within a local network, wherein forwarding, by the UPF over the network slice, the data packets associated with the data session between the device and the external system comprises forwarding the data packets to the next-hop interface based on the forwarding table.

8. A method implemented in a communication network between a compact core system and a central core network system for configuring and updating the compact core system, wherein the method comprises:
establishing, using a user plane function (UPF) at the compact core system, a connection between a compact access and mobility management function (AMF) at the compact core system and a central AMF at the central core network system over a network slice;
obtaining, by the central AMF, a routing policy associated with a plurality of different devices that are registered with the compact core system, wherein the routing policy indicates whether data from a first device is permitted to be transmitted to the central core network system, wherein when the data from the first device is permitted to be transmitted to the central core network system, the routing policy comprises one or more rules for transmitting the data between the first device and the central core network system;
transmitting, by the central AMF, the routing policy to the compact AMF over the network slice using the UPF;
storing, by the compact AMF, the routing policy in a data store of the compact core system to configure the compact core system according to the routing policy;
obtaining, by the central AMF, an update to the routing policy based on at least one of a request from an owner of the compact core system, a current network condition, or an update to a policy rule associated with the routing policy;
transmitting, by the central AMF, the update to the routing policy to the compact AMF over the network slice using the UPF; and
updating, by the compact AMF, the routing policy by re-configuring the compact core system according to the update to the routing policy.

9. The method of claim 8, wherein the routing policy indicates that data of a first type that is received from the first device registered with the compact core system is to be transmitted to the central core network system over a first predefined network slice having a first set of quality of service (QoS) parameters.

10. The method of claim 9, wherein an update to the routing policy indicates a second predefined network slice with a second set of QoS parameters, and wherein updating the routing policy comprises storing an updated routing policy in the data store, wherein the updated routing policy indicates that the data of the first type that is received from the first device is to be transmitted to the central core network system over the second predefined network slice.

11. The method of claim 8, wherein the routing policy indicates that data received from the first device registered with the compact core system is to be encrypted according to a first encryption algorithm using a predefined encryption key prior to transmission.

12. The method of claim 11, wherein an update to the routing policy indicates that the data received from the first device is to be encrypted according to a second encryption algorithm using a second predefined encryption key prior to transmission, and wherein updating the routing policy comprises storing an updated first routing policy in the data store, wherein the updated first routing policy indicates that the data received from the first device is to be encrypted according to a second encryption algorithm using a second predefined encryption key prior to transmission.

13. The method of claim 8, wherein the routing policy indicates that raw data received from devices registered with the compact core system is prohibited from being forwarded to an external system, but an encrypted version of the raw data is permitted to be forwarded to the external system.

14. A compact core system, comprising:
one or more memories comprising:
a first data store configured to maintain a plurality of routing policies associated with a plurality of different devices that are registered with the compact core system, wherein each of the routing policies indicates rules for transmitting data to one or more other systems; and
a second data store configured to maintain a plurality of policy rules associated with the different devices that are registered with the compact core system, wherein the policy rules are based on a subscription of the different devices and define at least one of an allocation or management of network resources for transmitting data between a first device and a central core network system;
one or more processors;
a compact access and mobility management function (AMF) comprising instructions stored in the one or more memories, which when executed by the one or more processors, cause the compact AMF to be configured to establish a secure connection with a central AMF at a central core network system over a network slice using a user plane function (UPF) at the compact core system; and
a compact session management function (SMF) comprising instructions stored in the one or more memories, which when executed by the one or more processors, cause the compact SMF to be configured to establish a data session with the first device that is registered with the compact core system;
wherein the compact AMF is further configured to:
obtain the data either from the first device or based on the first device; and
transmit the data to the central AMF over the network slice using the UPF, based on a routing policy of the routing policies indicating that the data is permitted to be transmitted and stored at the central core network system.

15. The compact core system of claim 14, wherein the network slice may be a dedicated network slice for communications between the compact core system and the central core network system, and wherein the network slice employs at least one of encryption protocols, authentication mechanisms, access controls, or auditing.

16. The compact core system of claim 14, wherein when the data is obtained from the first device, the data comprises content generated at the first device and received at the compact core system for forwarding to the central core network system.

17. The compact core system of claim 14, wherein when the data is based on the first device, the data comprises usage data indicating an amount of data used by the first device during one or more data sessions during a predefined period of time.

18. The compact core system of claim 14, wherein the data session is established over a second network slice that meets quality of service (QoS) parameters associated with the first device.

19. The compact core system of claim 14, wherein the first device is registered with the compact core system when the first device is authenticated with the compact core system or when the first device has established another data session with a second device or external system using the compact core system.

20. The compact core system of claim 14, wherein the compact AMF is further configured to store the data in a third data store of the compact core system.
